(19) United States
(12) Patent Application Publication
(10) Pub. No.: US 2023/0267593 A1
(43) Pub. Date: Aug. 24, 2023

(54) WORKPIECE MEASUREMENT METHOD, WORKPIECE MEASUREMENT SYSTEM, AND PROGRAM

(71) Applicant: Kabushiki Kaisha Kobe Seiko Sho (Kobe Steel, Ltd.), Kobe-shi (JP)

(72) Inventors: Tatsuya YOSHIMOTO, Kobe-shi (JP); Akira OKAMOTO, Kobe-shi (JP)

(73) Assignee: Kabushiki Kaisha Kobe Seiko Sho (Kobe Steel, Ltd.), Kobe-shi (JP)

(21) Appl. No.: 18/164,882

(22) Filed: Feb. 6, 2023

(30) Foreign Application Priority Data
Feb. 24, 2022 (JP) 2022-026733

(51) Int. Cl. G06T 7/00; G06T 7/50; G06T 7/70

(52) U.S. Cl. CPC G06T 7/0004; G06T 7/50; G06T 7/70; G06T 2200/04; G06T 2200/08; G06T 2200/24; G06T 2207/10028; G06T 2207/30164

(57) ABSTRACT

The shape and the position of a workpiece are measured without having to prepare three-dimensional CAD data in advance. A workpiece measurement method for measuring a shape and a position of a workpiece constituted of a plurality of components includes: an acquiring step for acquiring three-dimensional point, cloud data of the workpiece; an outline estimating step for estimating at least one boundary frame indicating an outline corresponding to each of the plurality of components by using the point cloud data and a condition defined in correspondence with the shape of the workpiece serving as a measurement target; and an optimizing step for optimizing the at least one boundary frame estimated in the outline estimating step by adjusting a parameter in accordance with an evaluation function, and identifying a shape of each of the plurality of components.

### BACKGROUND OF THE INVENTION

### 1. Field of the Invention

The present, invention relates to workpiece measurement methods, workpiece measurement systems, and programs.

### 2. Description of the Related Art

In the related art, a welding robot is used for preparing a weld member (also referred to as “workpiece” hereinafter) at a predetermined position and for welding the workpiece. In such a case, for the purpose of automatically welding the workpiece, it is demanded that the set state of the workpiece is readily ascertainable to save labor. When the position of the workpiece is to be ascertained, for example, three-dimensional data acquired using a three-dimensional sensor is used.

Japanese Unexamined Patent Application Publication No. 2018-156566 discloses an example where three-dimensional data is used. This example involves identifying two members from three-dimensional computer-aided-design (CAD) data and identifying a weld line by extracting a shared edge between the two members. Japanese Patent No. 6917096 discloses a configuration that determines a difference value from reference three-dimensional model data of a reference object measured in advance and three-dimensional data of an actual object at the time of operation.

### SUMMARY OF THE INVENTION

For example, it is assumed in Japanese Unexamined Patent Application Publication No. 2018-156566 that three-dimensional CAD data is used, and if such data is not present, it is not possible to identify the weld line. In Japanese Patent No. 6917096, the main purpose is to correct an amount of displacement between members, and the three-dimensional model data needs to be acquired in advance. This is problematic in terms of an inability to cope with a change in the size and shape of the object.

An object of the present invention to measure the shape and the position of a workpiece without having to prepare three-dimensional CAD data in advance.

In order to solve the aforementioned problem, the present invention has the following configuration. Specifically, a workpiece measurement method for measuring a shape and a position of a workpiece constituted of a plurality of components includes: an acquiring step for acquiring three-dimensional point cloud data of the workpiece; an outline estimating step for estimating at least one boundary frame indicating an outline corresponding to each of the plurality of components by using the point cloud data and a condition defined in correspondence with the shape of the workpiece serving as a measurement target; and an optimizing step for optimizing the at least one boundary frame estimated in the outline estimating step by adjusting a parameter in accordance with an evaluation function, and identifying a shape of each of the plurality of components.

Another aspect of the present invention has the following configuration. Specifically, a workpiece measurement system that measures a shape and a position of a workpiece constituted of a plurality of components includes: acquiring means for acquiring three-dimensional point cloud data of the workpiece; outline estimating means for estimating at least one boundary frame indicating an outline corresponding to each of the plurality of components by using the point cloud data and a condition defined in correspondence with the shape of the workpiece serving as a measurement target; and optimizing means for optimizing the at least one boundary frame estimated by the outline estimating means by adjusting a parameter in accordance with an evaluation function, and identifying a shape of each of the plurality of components.

Another aspect of the present invention has the following configuration. Specifically, a program causes a computer to execute a process including: an acquiring step for acquiring three-dimensional point cloud data of a workpiece constituted of a plurality of components; an outline estimating step for estimating at least one boundary frame indicating an outline corresponding to each of the plurality of components by using the point cloud data and a condition defined in correspondence with a shape of the workpiece serving as a measurement target; and an optimizing step for optimizing the at least one boundary frame estimated in the outline estimating step by adjusting a parameter in accordance with an evaluation function, and identifying a shape of each of the plurality of components.

According to the present invention, the shape and the position of a workpiece can be measured without having to prepare three-dimensional CAD data in advance.

### BRIEF DESCRIPTION OF THE DRAWINGS

FIG. 1 is a block diagram schematically illustrating a workpiece measurement system according to an embodiment of the present invention;

FIG. 2 is a block diagram illustrating an example of a functional configuration of an information processing apparatus according to an embodiment of the present invention;

FIG. 3 illustrates an example of point cloud data according to an embodiment of the present invention;

FIG. 4 schematically illustrates an example of a workpiece according to an embodiment of the present invention;

FIG. 5 is a flowchart illustrating an overall process according to an embodiment of the present invention;

FIG. 6 is a flowchart illustrating an outline estimation process according to an embodiment of the present invention;

FIG. 7 is a diagram for explaining the outline estimation process according to the embodiment of the present invention;

FIG. 8 is a graph for explaining the outline estimation process according to the embodiment of the present invention;

FIG. 9 is a flowchart of an optimization process according to an embodiment of the present invention;

FIG. 10 is a diagram for explaining a measurement result according to an embodiment of the present invention;

FIG. 11 is a diagram for explaining a measurement result according to an embodiment of the present invention;

FIG. 12 is a diagram for explaining a measurement result according to an embodiment of the present invention; and

FIG. 13 is a diagram for explaining a calculation of supplementary information according to an embodiment of the present invention.

### DESCRIPTION OF THE PREFERRED EMBODIMENTS

Embodiments of the present invention will be described below with reference to the drawings. The embodiments to be described below are used for explaining the present invention and are not intended to limit the interpretation of the present invention. Furthermore, not all of the components described in each embodiment are essential components for solving the problem of the present invention. Moreover, in the drawings, identical elements have corresponding relationships by being given the same reference signs.

### First Embodiment

An embodiment of the present invention will be described below with reference to the drawings. In each of the drawings used in the following description, three-dimensional coordinate axes indicated by an x-axis, a y-axis, and a z-axis correspond with one another. In the following description, a plane constituted of an x-axis direction and a y-axis direction is defined as a horizontal plane, and a z-axis direction orthogonal to these directions is defined as a height direction.

### Configuration of Measurement System

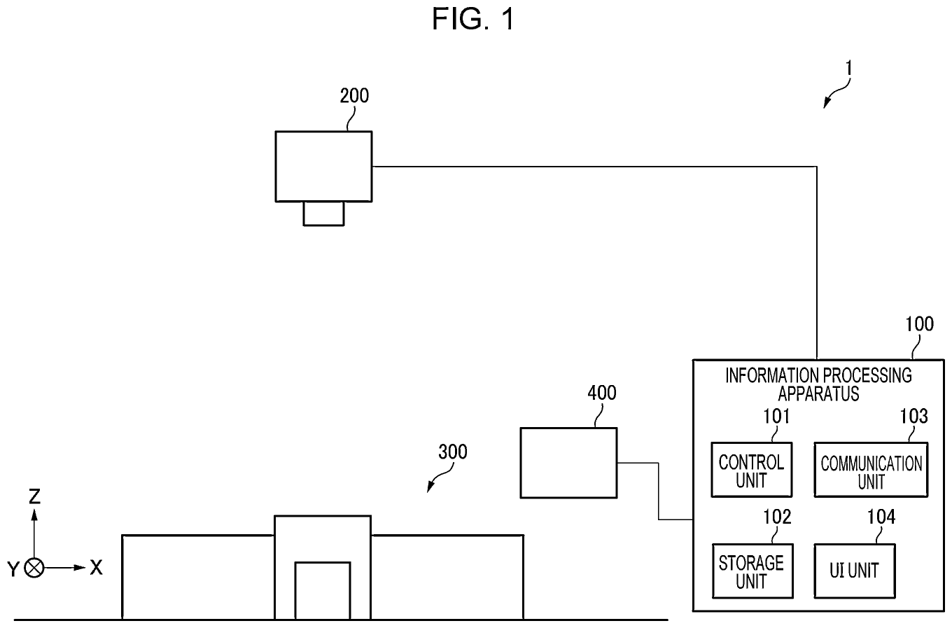

FIG. 1 is an overall view schematically illustrating a workpiece measurement system 1 according to this embodiment. The workpiece measurement system 1 is capable of implementing a workpiece measurement method according to this embodiment and includes an information processing apparatus 100 and a three-dimensional sensor 200. A workpiece 300 serving as a measurement target is disposed near the workpiece measurement system 1. In this embodiment, the workpiece 300 may be constituted of one or more components. The workpiece measurement system 1 may be, for example, integrated with or connected to a welding system that includes a touch-sensible welding robot. A touch-sensing function is for ascertaining the position and the shape of the workpiece 300. This embodiment relates to an example where the workpiece measurement system 1 is connected to a welding system 400 having a touch-sensing function and is capable of operating in cooperation therewith.

The information processing apparatus 100 is, for example, a personal computer (PC). If the workpiece measurement system 1 according to this embodiment is integrated with the welding system 400, the information processing apparatus 100 may be integrated with a controller for controlling a welding robot (not shown). The information processing apparatus 100 includes a control unit, 101, a storage unit, 102, a communication unit 103, and a user interface (UI) unit 104.

The control unit 101 used may be at least one of a central processing unit (CPU), a graphical processing unit (GPU), a micro-processing unit (MPU), a digital signal processor (DSP), and a field programmable gate array (FPGA). The storage unit 102 is a volatile or nonvolatile storage device, such as a hard disk drive (IIDD), a read-only memory (ROM), or a random access memory (RAM). The control unit 101 reads and executes various types of programs stored in the storage unit 102 so as to implement various types of functions to be described below.

The communication unit 103 communicates with an external device and various types of sensors. The communication unit 103 may use either a wired or wireless communication method, and the communication standard thereof is not limited. The UI unit 104 receives an operation from a user and displays a measurement result. For example, the UI unit 104 may include a mouse and/or a keyboard, or may be constituted of a touchscreen display having a combination of a display unit and an operation unit. The units in the information processing apparatus 100 are connected in a communicable manner by an internal bus (not shown).

The three-dimensional sensor 200 is a senor for acquiring point cloud data as three-dimensional data. The three-dimensional sensor 200 used may be, for example a time-of-flight (ToF) camera, a stereo camera, or a light-detection-and-ranging (LiDAR) device. Since these sensors have different characteristics, an appropriate sensor to be used may be selected in accordance with the measurement environment or the workpiece 300 serving as the measurement target.

A ToF camera radiates laser light onto the measurement target and measures the reflected laser light by using an imaging element, so as to calculate the distance for each pixel. The distance measurable by a ToF camera ranges between, for example, several tens of centimeters to several meters. A stereo camera uses a plurality of images captured with a plurality of (e.g., two) cameras to calculate the distance based on the parallax of the images. The distance measureable by a stereo camera ranges between, for example, several tens of centimeters to several meters. A LiDAR device radiates laser light to the surrounding environment and calculates the distance by measuring the reflected laser light. The distance measureable by a LiDAR device ranges between, for example, several tens of centimeters to several meters.

This embodiment relates to an example where a ToF camera is used as the three-dimensional sensor 200. In this embodiment, the three-dimensional sensor 200 is disposed above the workpiece 300 and is capable of capturing an image of the workpiece 300 located therebelow. The three-dimensional sensor 200 may be fixed, or may be adjustable in terms of the vertical and horizontal positions, the imaging angle, and the imaging conditions in accordance with the imaging process.

### Functional Configuration

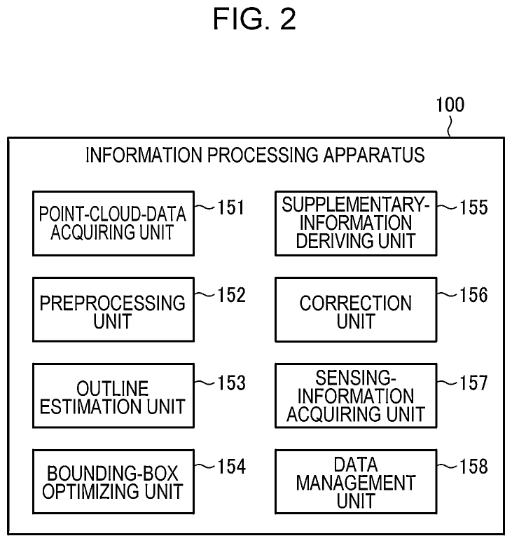

FIG. 2 illustrates an example of the functional configuration of the information processing apparatus 100 that executes a process in accordance with the workpiece measurement method according to this embodiment. Units shown in FIG. 2 may each be implemented by the control unit 101 of the information processing apparatus 100 reading a program stored in the storage unit 102 and executing the program. The information processing apparatus 100 includes a point-cloud-data acquiring unit 151, a preprocessing unit 152, an outline estimation unit 153, a bounding-box optimizing unit 154, a supplementary-information deriving unit 155, a correction unit 156, a sensing-information acquiring unit 157, and a data management unit 158.

The point-cloud-data acquiring unit 151 acquires point cloud data serving as three-dimensional data of the workpiece 300 image-captured by the three-dimensional sensor 200. The preprocessing unit 152 performs preprocessing on the acquired point cloud data. The preprocessing may vary depending on the point cloud data to be used. Examples of the preprocessing include filtering, outlier removal, clustering, and coordinate conversion.

The outline estimation unit 153 estimates an outline of the workpiece 300 indicated in the point cloud data by using a bounding box. The outline corresponds to the shape of the workpiece 300 approximated based on the point cloud data. The bounding-box optimizing unit 154 optimizes the shape of the workpiece 300 for more accurate identification based on the bounding box indicating the outline of the workpiece 300 estimated by the outline estimation unit 153. Although a specific example of the bounding box according to this embodiment will be described later, the bounding box indicates at least one rectangular or circular boundary frame for expressing the shape of at least one component constituting the workpiece 300. The bounding box may be indicated with a two-dimensional shape, that is, a planar shape, or with a three-dimensional shape. Therefore, the bounding box is not limited to having a rectangular shape constituted of straight lines, and may partially include a curved line. Furthermore, the bounding box and each component constituting the workpiece 300 do not necessarily have to be in a one-to-one relationship, and may be in a one-to-multiple relationship depending on the shape of the workpiece 300 or the imaging direction of the point, cloud data. The supplementary-information deriving unit 155 derives supplementary information for identifying the positional coordinates of the workpiece 300 in a three-dimensional coordinate system. An example of the supplementary information will be described later.

Based on information acquired using the touch-sensing function provided by the welding system 400, the correction unit 156 corrects the bounding box obtained by the bounding-box optimizing unit 154 for further improving the measurement accuracy. The sensing-information acquiring unit 157 acquires measurement information to be used by the correction unit 156 via the touch-sensing function provided by the welding system 400. The sensing-information acquiring unit 157 may be configured to cause the welding system 400 to perform the measurement by using the touch-sensing function. The data management unit 158 retains and manages various types of data acquired via the three-dimensional sensor 200 and the touch-sensing function, as well as data generated during the measurement process. After the shape and the position of the workpiece are ascertained in accordance with the workpiece measurement method according to this embodiment, touch-sensing is performed so that the position of the workpiece can be ascertained more accurately. Accordingly, the position of a highly-accurate weld line can be ascertained, thereby enabling robot welding.

Point, Cloud Data

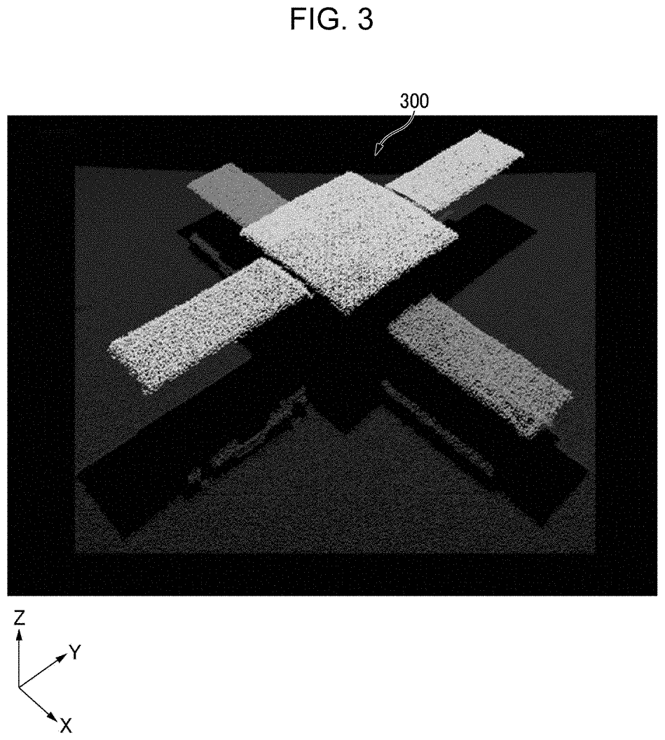

FIG. 3 illustrates an example of point cloud data obtained as a result, of the three-dimensional sensor 200 capturing an image of the workpiece 300. In this example, the image of the workpiece 300 is captured from above and is shown as viewed at an angle. When viewed from above, the workpiece 300 in this example is a cross-shaped workpiece having one diaphragm located at the center and four beam flanges extending from four sides of the diaphragm. An example of the workpiece 300 is a steel-framed joint workpiece.

The shape, configuration, and size of the workpiece 300 are not particularly limited. Examples of the configuration having a diaphragm and beam flanges include a T-shaped configuration having one diaphragm and three beam flanges and an L-shaped or I-shaped configuration having one diaphragm and two beam flanges. Other configurational elements may include stepped connections between the diaphragm and the beam flanges and offset connections between the diaphragm and the beam flanges.

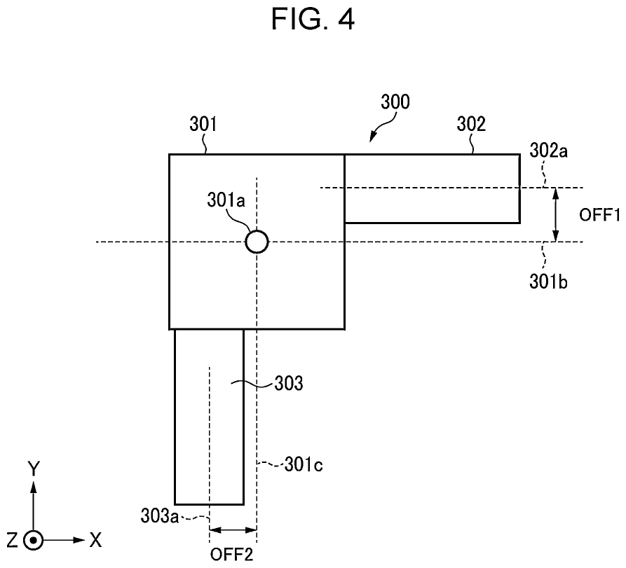

FIG. 4 illustrates elements to be measured on the workpiece 300 in the workpiece measurement method according to this embodiment. The example shown indicates an L-shaped workpiece having one diaphragm 301 and two beam flanges 302 and 303. A center point, 301a indicates the center of the diaphragm 301. A center line 301b extends in the x-axis direction through the center point 301a of the diaphragm 301. A center line 301c extends in the y-axis direction through the center point 301a of the diaphragm 301. A center line 302a extends in the x-axis direction of the beam flange 302 and corresponds to a crosswise center position of the beam flange 302. A center line 303a extends in the y-axis direction of the beam flange 303 and corresponds to a crosswise center line of the beam flange 303. The center line 302a and the center line 301b are parallel to each other, and a difference therebetween is indicated as an offset OFF1. The center line 303a and the center line 301c are parallel to each other, and a difference therebetween is indicated as an offset OFF2. In the following description, the crosswise direction of each beam flange may also be referred to as a widthwise direction, and the longitudinal direction thereof may also be referred to as a lengthwise direction.

In the following description, the point cloud data and the shape of the workpiece described above will be described as an example. However, the workpiece is not limited to having such a shape, and the present invention is applicable to a workpiece having a different shape.

Processing Flow

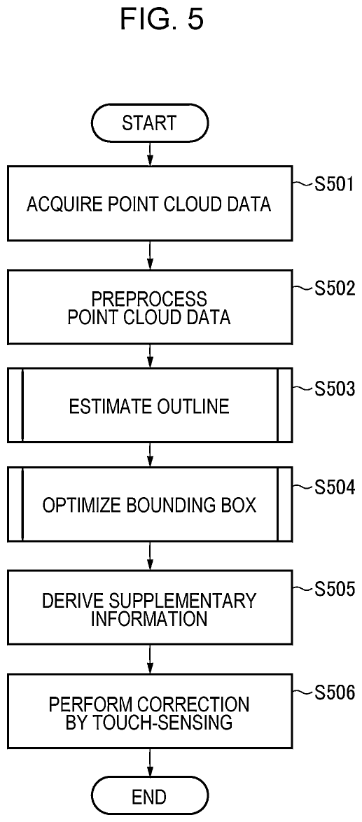

The flow of a workpiece measurement process according to this embodiment will be described below. FIG. 5 is a flowchart illustrating the flow of the overall workpiece measurement process according to this embodiment. Each step is implemented by the units of the information processing apparatus 100 shown in FIG. 2 operating in cooperation with each other. In order to simplify the description, the subject of the process will be collectively described as the information processing apparatus 100. Before the flow of this process commences, it is assumed that the workpiece 300 is disposed at a position where an image thereof can be captured by the three-dimensional sensor 200.

In step S501, the information processing apparatus 100 acquires point cloud data serving as three-dimensional data captured by using the three-dimensional sensor 200. If the workpiece 300 is smaller than a predetermined size, the point cloud data may be acquired in a single imaging process. If the workpiece 300 is larger than the predetermined size, a plurality of pieces of point cloud data may be acquired by performing the imaging process multiple times and may then be integrated. If the workpiece 300 has a predetermined shape, such as the shape of a steel-framed joint, it is preferable that the image of the workpiece 300 be captured from directly thereabove to eliminate blind spots as much as possible. In this step, the imaging position and the imaging angle may be adjusted by the information processing apparatus 100 or may be designated by the user of the workpiece measurement system 1 when the imaging process is to be performed.

In step S502, the information processing apparatus 100 performs preprocessing on the point cloud data acquired in step S501. Examples of the preprocessing include filtering, outlier removal, clustering, and coordinate conversion. The preprocessing in this step may be omitted so long as required processing is executed in accordance with the configuration of the point cloud data acquired in step S501.

Filtering may involve, for example, resampling the point cloud included in the point cloud data at regular intervals by using a known voxel grid filter so as to keep the point cloud density per predetermined volume constant. Outlier removal may involve removing an outlier that may lower the measurement accuracy. For example, an outlier may be identified from statistical information, such as a variance and an average of adjacent point clouds, or may be identified from the number of adjacent point clouds existing within a predetermined radius. Clustering may involve, for example, splitting the point cloud included in the point cloud data into a plurality of groups based on distance and deleting a group in which the number of point clouds belonging thereto is smaller than or equal to a predetermined threshold value, so as to remove a point cloud other than the point cloud indicating the shape of the workpiece 300. Coordinate conversion involves converting the coordinate system of the three-dimensional sensor 200 into a predetermined coordinate system based on the imaging position and the imaging angle of the three-dimensional sensor 200. The predetermined coordinate system may be, for example, a coordinate system to be used in the touch-sensing function or a coordinate system in which the origin point and the coordinate axes are defined based on the surface, serving as an xy plane, on which the workpiece 300 is set, as shown in FIG. 1. The parameters required for the conversion of the coordinate system may be derived in accordance with calibration performed in advance.

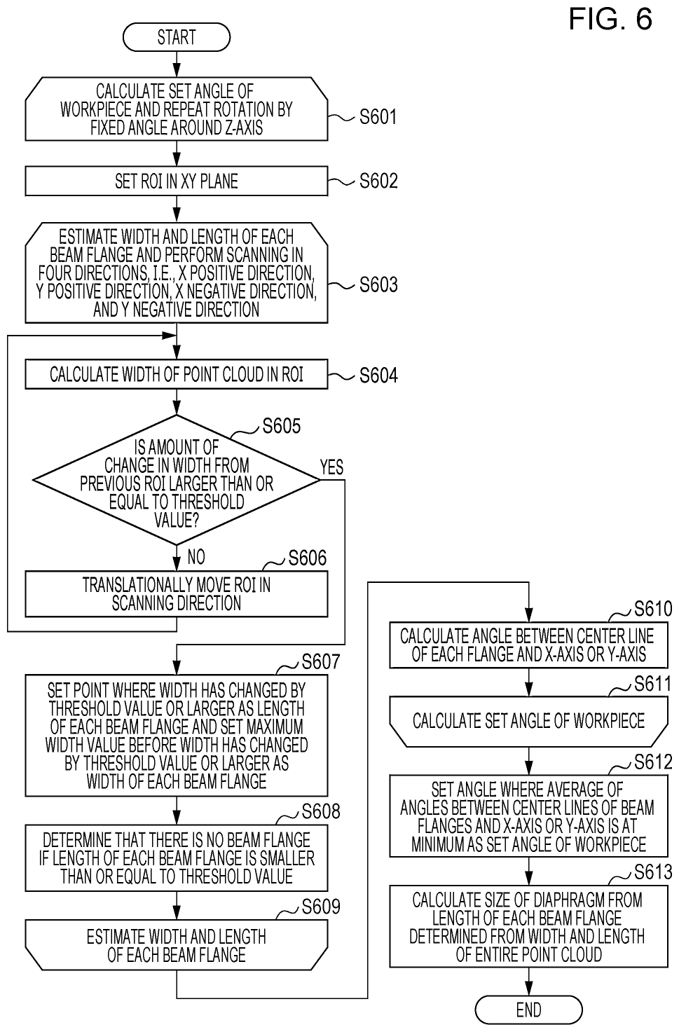

In step S503, the information processing apparatus 100 performs an outline estimation process by using the point cloud data processed in step S502. The details of this step will be described later with reference to FIGS. 6 to 8. As a result of this step, at least one bounding box indicating the outline of the workpiece 300 is obtained.

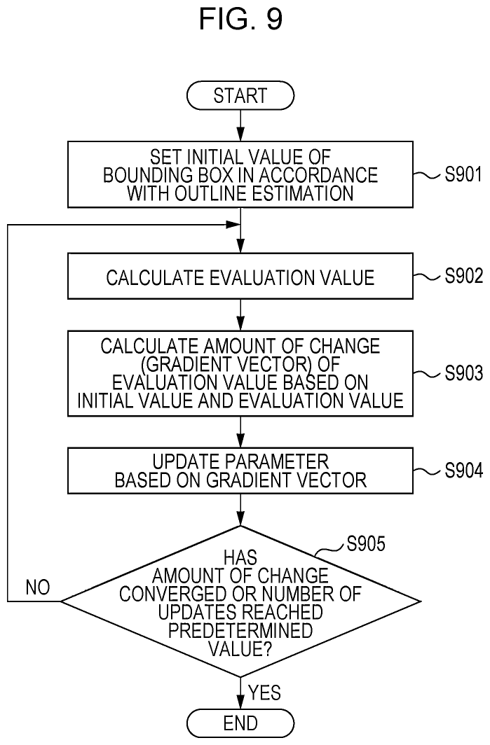

In step S504, the information processing apparatus 100 performs a correction by optimizing the bounding box obtained in step S503. The details of this step will be described later with reference to FIG. 9.

In step S505, the information processing apparatus 100 derives supplementary information for identifying the positional coordinates of the workpiece 300 in the three-dimensional coordinate system. The supplementary information includes, for example, height information of each of the components that constitute the workpiece 300. For example, as shown in FIG. 3, the upper surfaces of the diaphragm and the beam flanges constituting the workpiece 300 are not necessarily horizontal and may vary in height depending on the positions thereof. Therefore, in order to measure the shape of the workpiece 300 more accurately, the height information may be included as the supplementary information. In addition, an angle between the surface of each component and the horizontal plane may be included as the supplementary information.

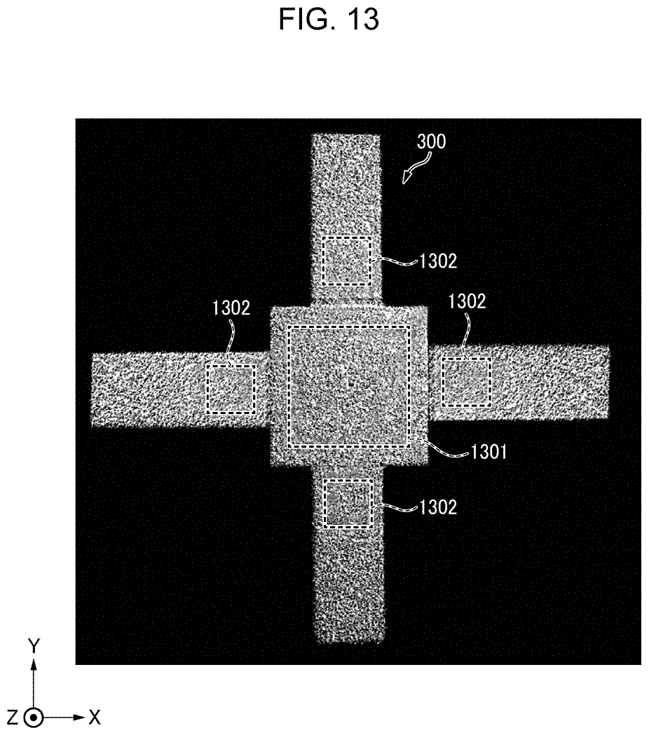

FIG. 13 is a diagram for explaining the calculation of a parameter in the z-axis direction, that is, the height, as the supplementary information. This example is similar to the example in FIG. 3 in that the workpiece 300 is a cross-shaped workpiece having one diaphragm and four beam flanges. With regard to the diaphragm, the height of the diaphragm is calculated by using height information within a region 1301 excluding point cloud data of a peripheral region located within a predetermined range from the boundary, assuming that the measurement accuracy for the point cloud data is low in the peripheral region. Each of the beam flanges is similarly treated such that the measurement accuracy for the point cloud data is low in a peripheral region. Furthermore, height, information about, a position adjacent to the diaphragm is used. Therefore, when the height, of each beam flange is to be calculated, height information of point cloud data in each region 1302 is used.

In step S506, the information processing apparatus 100 performs a correction based on the information acquired using the touch-sensing function. This step may be executed after the information processing apparatus 100 determines whether or not to perform the touch-sensing process using the touch-sensing function and the correction process based on the measurement results obtained from the previous steps. Alternatively, the user using the workpiece measurement system 1 may designate whether or not this step is to be performed. Therefore, this step may be omitted. Subsequently, the flow of this process ends.

Outline Estimation Process

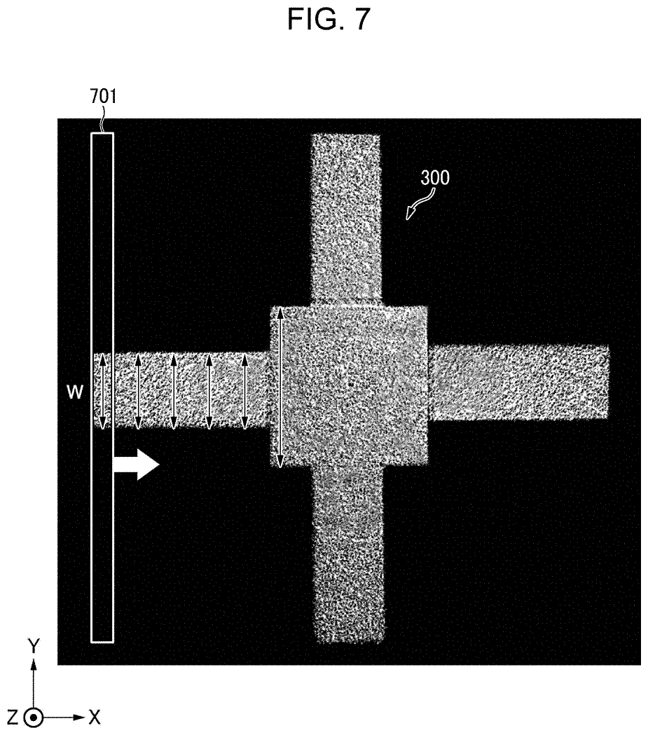

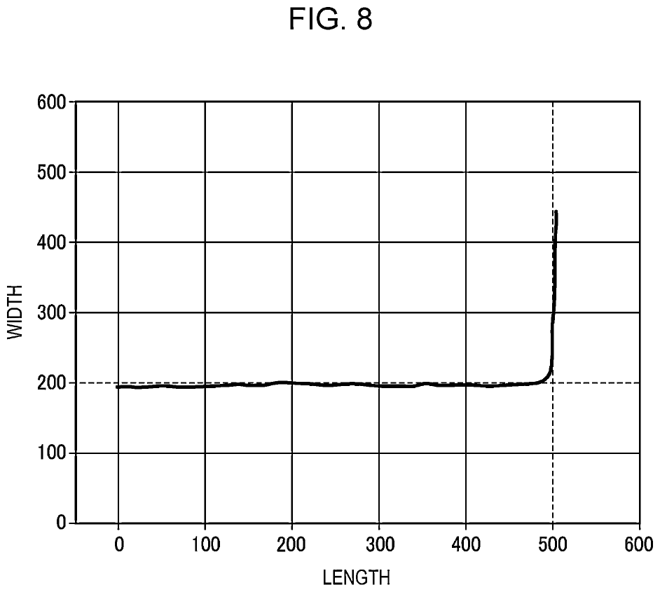

FIG. 6 is a flowchart of the outline estimation process according to this embodiment and corresponds to step S503 in FIG. 5. First, the general overview of the outline estimation process will be described with reference to FIGS. 7 and 8.

FIG. 7 illustrates point cloud data in a case where an image of the workpiece 300 is captured from directly thereabove by the three-dimensional sensor 200. Specifically, the point, cloud data shown in FIG. 3 has been converted such as to be projected onto a two-dimensional plane. In this example, the workpiece 300 is cross-shaped. The outline estimation process involves estimating the outline sequentially from a plurality of directions defined in accordance with the shape of the workpiece 300 serving as the measurement target. For example, in the case where the workpiece 300 is cross-shaped, the operation is performed in four directions, namely, from right to left and from left to right in the x-axis direction and from up to down and from down to up in the y-axis direction. The example in FIG. 7 relates to a case where the operation is performed from left to right along the x-axis. Furthermore, a region-of-interest 701 is set, and the outline estimation is performed while the region-of-interest 701 is shifted. FIG. 7 illustrates an example where the width of the left beam flange among the four beam flanges constituting the workpiece 300 is estimated as an outline from left to right in the x-axis direction.

FIG. 8 is a diagram for explaining the outline estimation process shown in FIG. 7 and is a graph illustrating an example of results of the outline estimation in FIG. 7. In FIG. 8, the abscissa axis indicates a detection result in a first axial direction (i.e., the x-axis direction in the example in FIG. 7), and the ordinate axis indicates a detection result in a second axial direction (i.e., the y-axis direction in the example in FIG. 7). In the measurement, example in FIG. 7, the abscissa axis corresponds to the length of each beam flange, whereas the ordinate axis corresponds to the width of each beam flange. Furthermore, on the abscissa axis, the position where the point cloud detection is started while the region-of-interest 701 is moved is indicated as “0”. The numerical values on each axis are examples and may vary depending on, for example, the size of the workpiece 300 serving as the measurement target. By identifying the point cloud data corresponding to the beam flanges, as shown in FIG. 7, the width of each of the beam flanges constituting the workpiece 300, that is, the outline of the workpiece 300, can be estimated. In this example, the width of each beam flange can be estimated to be “200”. As the estimation is continuously performed, the value of the width rapidly increases at the position where the length is “500”. Accordingly, the length of each beam flange can be estimated to be “500”.

As mentioned above, the outline estimation is performed by scanning the point cloud data from four directions in the example in FIG. 7. In this case, the direction of the outline estimation may be switched at the timing when the measurement value rapidly changes, as in FIG. 8. Alternatively, the outline estimation process may be performed on all pieces of point cloud data from all directions. The following description relates to a case where the direction of the outline estimation is switched when the measurement, value changes to a threshold value or larger.

Examples of bounding-box information obtained in accordance with the outline estimation include the following items. Depending on the shape of the workpiece 300 serving as the measurement target, information to be indicated below may partially be designated by the user.

Shape: rectangular, circular, cubic, etc.

Size: the length of the long sides, the length of the short sides, the center coordinates, the angle, etc. if the shape is rectangular

Number: the number of bounding boxes per shape

Limitations: the connection relationship and positional relationship between bounding boxes

Referring back to FIG. 6, the flowchart corresponding to the process in FIG. 7 will now be described. It is assumed in the flow of this process that conditions according to the shape of the workpiece 300 are defined for performing the outline estimation on the workpiece 300 for acquiring the aforementioned bounding-box information. For example, if the workpiece 300 is cross-shaped, as shown in FIG. 3, and is a steel-framed joint workpiece, the conditions for the outline estimation are as follows.

Shape: rectangular

Size: variable depending on the component

Number: one diaphragm and two to four beam flanges

Limitations: the short sides of each beam flange are in contact with one side of the diaphragm, and different beam flanges are not in contact with each other

Under the aforementioned estimation conditions, the outline estimation is performed on the workpiece 300. The estimation conditions for the outline estimation are preliminarily defined in accordance with the shape of the workpiece 300. Furthermore, the estimation conditions are not limited to the above, and arbitrary estimation conditions may be defined. The aforementioned conditions for performing the outline estimation may be preliminarily defined in accordance with the type of the workpiece 300 serving as the measurement target.

Furthermore, in order to estimate the outline of each of the joints of the components constituting the workpiece 300, the workpiece 300 needs to be observed from thereabove, that is, from a direction parallel to the z-axis direction in FIG. 1. Therefore, if the point cloud data as shown in FIG. 3 is to be used, the point cloud data is rotated and is converted so as to be viewed from above, as shown in FIG. 7. This conversion may be performed in the preprocessing in step S502 in FIG. 5.

A loop process from step S601 to step S611 is repeatedly performed on the point cloud data for every predetermined angle around the z-axis in the xy plane shown in FIG. 1. The predetermined angle and the start angle may be preliminarily defined. For example, the predetermined angle may be set to 5 degrees, and the start angle may be set to an angle (0 degrees) with reference to the direction of the x-axis in the xy plane.

In step S602, the outline estimation unit 153 sets the region-of-interest 701 in the xy plane of the point cloud data. The region-of-interest 701 to be set here corresponds to the start position for the outline estimation and may include a plurality of regions-of-interest set in accordance with the number of pieces of point cloud data in the scanning direction. Furthermore, the size of the region-of-interest 701 is not particularly limited. For example, the region-of-interest 701 used may have a fixed size or may have a size defined in accordance with the image size of the point cloud data.

Subsequently, a loop process from step S603 to step S609 is repeatedly performed on the point cloud data for every predetermined direction in the xy plane. It is assumed that the point cloud data is scanned in four scanning directions, namely, the x-axis positive direction, the y-axis positive direction, the x-axis negative direction, and the y-axis negative direction. With regard to the scanning directions, the directions and the number thereof may be defined based on the aforementioned estimation conditions.

In step S604, the outline estimation unit 153 calculates the width of the point cloud in the set region-of-interest 701.

In step S605, the outline estimation unit 153 determines whether or not a difference, that is, an amount of change, between the width of the point cloud calculated in step S604 and the width calculated at the position of a previous region-of-interest 701 is larger than or equal to a threshold value. It is assumed that the threshold value is defined in advance. The determination may be performed by using a rate of change in place of the amount of change. If the amount of change is larger than or equal to the threshold value (YES in step S605), the outline estimation unit 153 proceeds to step S607. In contrast, if the amount of change is smaller than the threshold value (NO in step S605), the outline estimation unit 153 proceeds to step S606.

In step S606, the outline estimation unit 153 translationally moves the region-of-interest 701 in the scanning direction. It is assumed that the amount of movement of the region-of-interest 701 is defined in advance in accordance with, for example, the size of the region-of-interest 701. Then, the outline estimation unit 153 returns to step S604 and repeats the process.

In step S607, the outline estimation unit, 153 sets the previous value at, the position where the amount of change is larger than or equal to the threshold value as the width of each beam flange, and sets the length from the position where the point cloud is detected to the position where the amount of change is larger than or equal to the threshold value as the length of each beam flange.

In step S608, if the length of each beam flange set in step S607 is smaller than or equal to the threshold value, the outline estimation unit 153 determines that there is no beam flange in the relevant direction. In other words, the outline estimation unit 153 sets the number of beam flanges.

In step S609, the outline estimation unit 153 determines whether or not the scanning is completed from all the scanning directions. If the scanning from all the scanning directions is not completed, the outline estimation unit 153 switches to an unprocessed scanning direction and repeats the process from step S604 onward. In contrast, if the scanning from all the scanning directions is completed, the outline estimation unit 153 proceeds to step S610.

In step S610, the outline estimation unit 153 calculates an angle between the center line of each beam flange and the x-axis or the y-axis in the xy plane.

In step S611, the outline estimation unit 153 determines whether or not the calculation is completed for all the rotational angles. If the calculation is not, completed for all the rotational angles, the outline estimation unit 153 changes the current, rotational angle to the next rotational angle and repeats the process from step S602 onward. In contrast, if the calculation is completed for all the rotational angles, the outline estimation unit 153 proceeds to step S612.

In step S612, the outline estimation unit 153 sets the rotational position at an angle where an average of the angles between the center lines of the beam flanges constituting the workpiece 300 and the x-axis or the y-axis is at a minimum as a set angle for the workpiece. Specifically, in the xy plane, the rotational angle of the point cloud data around the z-axis is set such that the x-axis and the y-axis are parallel to each beam flange.

In step S613, the outline estimation unit 153 calculates the size of the diaphragm constituting the workpiece 300 from the width and the length of the entire point cloud and the calculated length of each beam flange. The size of the diaphragm can be calculated based on the aforementioned estimation conditions. Accordingly, one or more bounding boxes indicating the outline of the entire workpiece 300 can be generated. For example, in the case of the workpiece 300 having the shape in FIG. 7, a total of five bounding boxes respectively corresponding to one diaphragm and four beam flanges can be generated. In other words, the outlines of the components constituting the workpiece 300 are identified in accordance with the parameters of the bounding boxes. Then, the flow of this process ends.

Bounding-Box Optimization Process

FIG. 9 is a flowchart of a bounding-box optimization process according to this embodiment and corresponds to step S504 in FIG. 5.

In step S901, the bounding-box optimizing unit 154 sets the parameter of each bounding box obtained in accordance with the outline estimation process in step S503 in FIG. 5 as an initial value. Specifically, by performing an optimization process with reference to the parameters obtained in accordance with the outline estimation process, the measurement accuracy can be enhanced.

In step S902, the bounding-box optimizing unit 154 calculates an evaluation value by using an evaluation function. In this embodiment, the following expression (1) indicating a weighted linear sum according to the number of points in the point cloud and the point cloud density is used as the evaluation function.

F(x)=W_{N}N(x)+W_{D}D(x) (1)

W_{N}, W_{D}: weighting factor

x: optimization parameter

N(x): the number of points existing within the bounding box

D(x): the point cloud density within the bounding box

Examples of the optimization parameter x used include the position, the angle, the width, and the length of the bounding box. More specifically, in the case of the workpiece 300 having the configuration shown in FIG. 4, the angle of the workpiece 300 around the z-axis, the center coordinates of the diaphragm, or the width, the length, or the offset of each beam flange may be used as the optimization parameter.

In step S903, the bounding-box optimizing unit 154 calculates an amount of change in the evaluation value based on the initial value set in step S901 and the evaluation value calculated in step S902. In this embodiment, the amount of change in the evaluation value is calculated while each optimization parameter is changed at predetermined intervals from the initial value.

In step S904, the bounding-box optimizing unit 154 updates the parameter based on a gradient vector calculated in step S903. In this case, for example, the parameter may be updated by using a known method, such as the method of steepest descent.

In step S905, the bounding-box optimizing unit 154 determines whether or not the amount of change in the parameter has converged within a predetermined range or the number of updates has reached a predetermined threshold value as a result of updating the parameter. If the amount of change in the parameter has converged within the predetermined range or the number of updates has reached the predetermined threshold value (YES in step S905), the flow of this process ends. Otherwise (NO in step S905), the bounding-box optimizing unit 154 returns to step S902 and repeats the process.

Processing Result

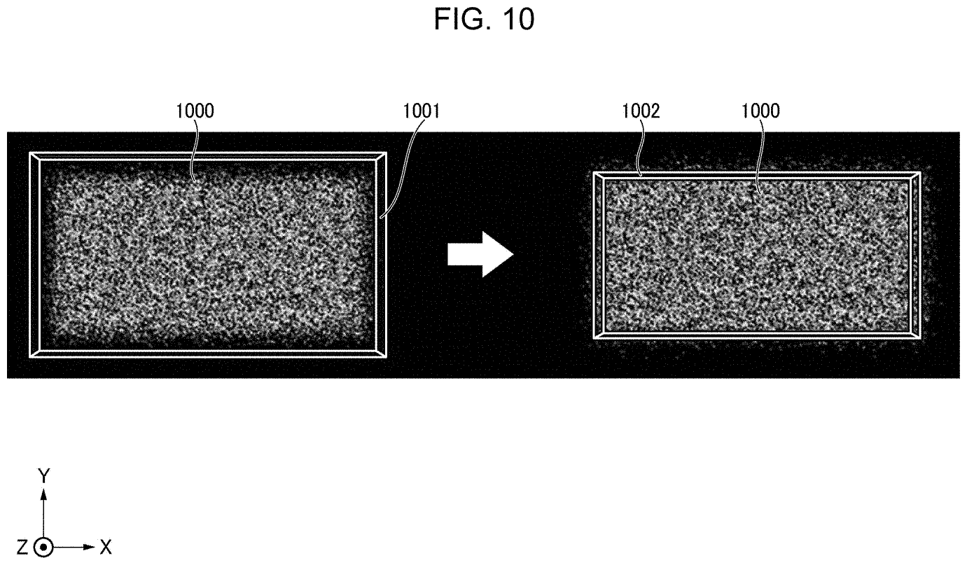

FIGS. 10 to 12 illustrate measurement results obtained in accordance with the workpiece measurement method according to this embodiment. In this case, a known oriented-bounding-box-based (OBB-based) method will be described as an example of a conventional method to be compared with the workpiece measurement method according to this embodiment.

FIG. 10 illustrates examples of bounding boxes as measurement results obtained using point cloud data 1000 of a certain workpiece. The point cloud data 1000 contains certain noise on the periphery thereof. A bounding box 1001 indicates a measurement result obtained in accordance with the conventional method, and a bounding box 1002 indicates a measurement result obtained in accordance with the workpiece measurement method according to this embodiment. The conventional method indicates a range larger than the point cloud indicating the actual workpiece due to the effect of noise. In contrast, in the workpiece measurement, method according to this embodiment, the bounding box 1002 obtained resembles the shape of the actual workpiece.

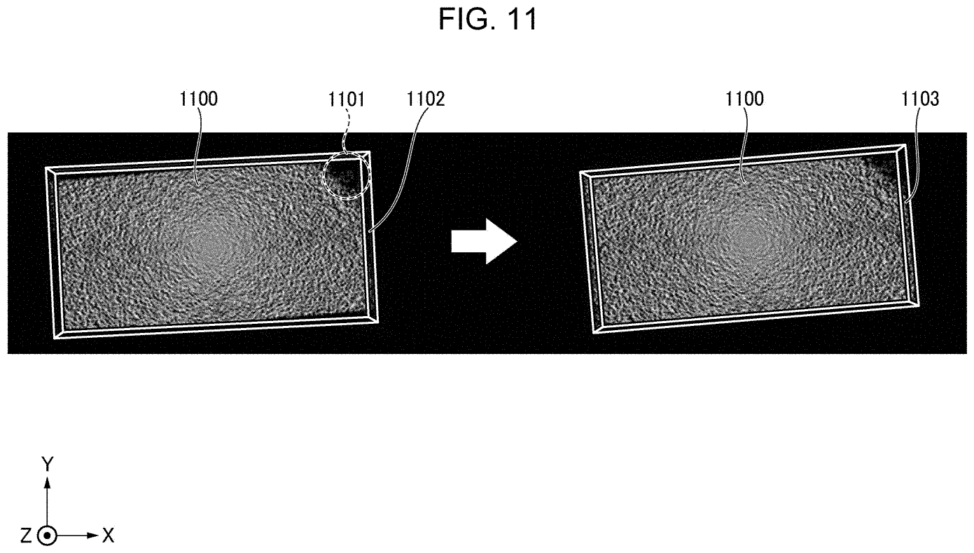

FIG. 11 illustrates examples of bounding boxes as measurement results using point cloud data 1100 of a certain workpiece. In the point cloud data 1100, an image of the workpiece using a three-dimensional camera is not properly performed and thus partially has a defect 1101. Abounding box 1102 indicates a measurement result obtained in accordance with the conventional method, and a bounding box 1103 indicates a measurement result obtained in accordance with the workpiece measurement method according to this embodiment. In the conventional method, the main axis is not properly identified due to the effect of the defect 1101, and an error has occurred in the angle and the size with respect to the point cloud indicating the actual workpiece. In contrast, in the workpiece measurement method according to this embodiment, the effect of the defect 1101 is suppressed, and the bounding box 1103 obtained resembles the angle and the size of the actual workpiece.

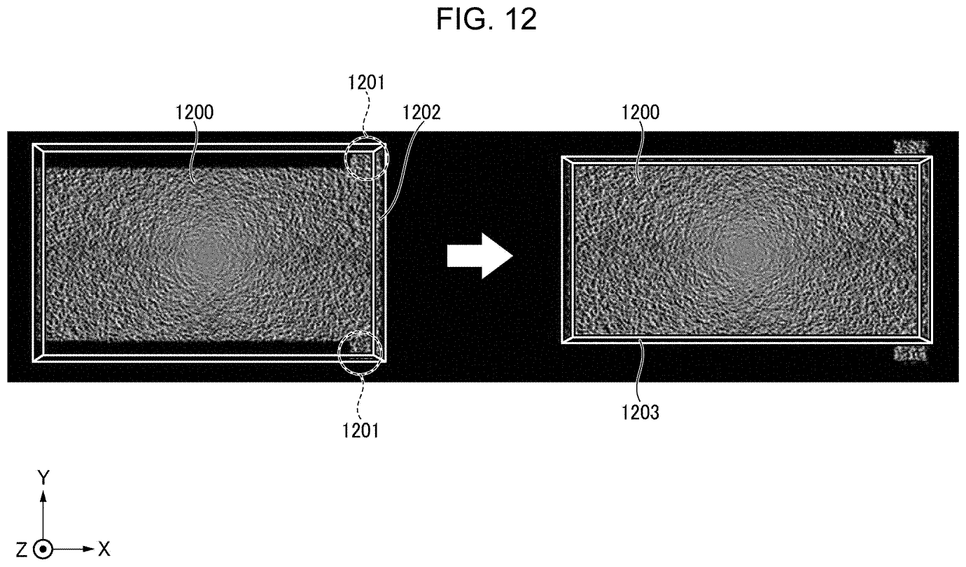

FIG. 12 illustrates examples of bounding boxes as measurement results using point cloud data 1200 of a certain workpiece. The point cloud data 1200 is provided with accessories at two locations of the workpiece and includes point, clouds 1201 corresponding to the accessories. A bounding box 1202 indicates a measurement result obtained in accordance with the conventional method, and a bounding box 1203 indicates a measurement result obtained in accordance with the workpiece measurement method according to this embodiment. The conventional method indicates a range larger than the point cloud indicating the actual workpiece due to the effect of the point clouds 1201. In contrast, in the workpiece measurement method according to this embodiment, point clouds 1201 smaller than a predetermined size are removed so that the effect thereof is suppressed, whereby the bounding box 1203 obtained resembles the shape of the actual workpiece.

According to this embodiment, the shape and the position of the workpiece can be measured without having to prepare three-dimensional CAD data in advance. Moreover, the shape of the workpiece can be ascertained more accurately than in the conventional method.

### Other Embodiments

The workpiece measurement method described in the above embodiment is applicable to a welding system including a welding robot. Accordingly, for example, a weld line can be extracted automatically in accordance with a target workpiece based on bounding-box information.

As an alternative to the above embodiment in which the shape of a workpiece is measured based on a viewpoint from above the workpiece, the measurement may be performed from multiple directions. Accordingly, the effect of blind spots can be suppressed, thereby enabling more-accurate measurement.

The above embodiment can be achieved by supplying a program or an application for implementing the functions of at least one embodiment described above to a system or an apparatus via a network or a storage medium and causing at least one processor in a computer of the system or the apparatus to load and execute the program.

Furthermore, the embodiment may be achieved in accordance with a circuit that implements at least one function. Examples of the circuit that implements at least one function include an application specific integrated circuit (ASIC) and a field programmable gate array (FPGA).

As described above, this description discloses the following items.

1. A workpiece measurement method for measuring a shape and a position of a workpiece constituted of a plurality of components includes: an acquiring step for acquiring three-dimensional point cloud data of the workpiece; an outline estimating step for estimating at least one boundary frame indicating an outline corresponding to each of the plurality of components by using the point cloud data and a condition defined in correspondence with the shape of the workpiece serving as a measurement target; and an optimizing step for optimizing the at least one boundary frame estimated in the outline estimating step by adjusting a parameter in accordance with an evaluation function, and identifying a shape of each of the plurality of components.

According to this configuration, the shape and the position of the workpiece can be measured without having to prepare three-dimensional CAD data in advance.

2. In the workpiece measurement method according to item 1, the condition includes any one of a shape, size, number, and limitation of a boundary frame corresponding to the workpiece.

According to this configuration, a bounding box of the workpiece can be estimated based on any one of the shape, size, number, and limitation as the condition corresponding to the workpiece.

3. In the workpiece measurement method according to item 1 or 2, the evaluation function is a weighted linear sum according to the number of points in a point cloud included in the boundary frame and a point cloud density.

According to this configuration, the bounding box can be optimized based on the weighted linear sum according to the number of points in the point cloud within the bounding box and the point, cloud density.

4. In the workpiece measurement method according to any one of items 1 to 3, the optimizing step includes optimizing the parameter including any one of a size, position, and angle of the boundary frame.

According to this configuration, at least one of the size, position, and angle of the bounding box can be optimized.

5. In the workpiece measurement method according to any one of items 1 to 4, the outline estimating step includes estimating the boundary frame by scanning the point cloud data from a plurality of directions.

According to this configuration, the outline of the workpiece can be estimated more accurately.

6. In the workpiece measurement method according to any one of items 1 to 5, the outline estimating step includes estimating an outline by projecting the point cloud data onto a two-dimensional plane.

According to this configuration, a shape from a desired direction obtained by projecting the point cloud data onto a two-dimensional plane can be accurately estimated.

7. The workpiece measurement, method according to item 6 further includes a deriving step for deriving a position corresponding to each of the plurality of components in an axial direction orthogonal to the two-dimensional plane.

According to this configuration, height information about each component constituting the workpiece relative to a two-dimensional plane can be further derived.

8. In the workpiece measurement method according to any one of items 1 to 7, the boundary frame includes a straight line or a curved line.

According to this configuration, the shape of the workpiece can be identified by using a bounding box having any shape.

9. In the workpiece measurement method according to any one of items 1 to 8, the boundary frame is indicated two-dimensionally or three-dimensionally.

According to this configuration, the shape of the workpiece can be identified by using a two-dimensional or three-dimensional bounding box.

10. The workpiece measurement method according to any one of items 1 to 9 further includes a correcting step for correcting the at least one boundary frame optimized in the optimizing step by using a measurement result obtained by performing touch-sensing on the workpiece.

According to this configuration, the measurement accuracy can be further enhanced by using the touch-sensing result.

11. A workpiece measurement, system that, measures a shape and a position of a workpiece constituted of a plurality of components includes: acquiring means for acquiring three-dimensional point cloud data of the workpiece; outline estimating means for estimating at least one boundary frame indicating an outline corresponding to each of the plurality of components by using the point cloud data and a condition defined in correspondence with the shape of the workpiece serving as a measurement target; and optimizing means for optimizing the at least one boundary frame estimated by the outline estimating means by adjusting a parameter in accordance with an evaluation function, and identifying a shape of each of the plurality of components.

According to this configuration, the shape and the position of the workpiece can be measured without having to prepare three-dimensional CAD data in advance.

12. A program causes a computer to execute a process including: an acquiring step for acquiring three-dimensional point cloud data of a workpiece constituted of a plurality of components; an outline estimating step for estimating at least one boundary frame indicating an outline corresponding to each of the plurality of components by using the point cloud data and a condition defined in correspondence with a shape of the workpiece serving as a measurement, target; and an optimizing step for optimizing the at least one boundary frame estimated in the outline estimating step by adjusting a parameter in accordance with an evaluation function, and identifying a shape of each of the plurality of components.

According to this configuration, the shape and the position of the workpiece can be measured without having to prepare three-dimensional CAD data in advance.

1. A workpiece measurement method for measuring a shape and a position of a workpiece constituted of a plurality of components, the workpiece measurement method comprising:
an acquiring step for acquiring three-dimensional point cloud data of the workpiece;
an outline estimating step for estimating at least one boundary frame indicating an outline corresponding to each of the plurality of components by using the point cloud data and a condition defined in correspondence with the shape of the workpiece serving as a measurement target; and
an optimizing step for optimizing the at least one boundary frame estimated in the outline estimating step by adjusting a parameter in accordance with an evaluation function, and identifying a shape of each of the plurality of components.

2. The workpiece measurement method according to claim 1, wherein the condition includes any one of a shape, size, number, and limitation of a boundary frame corresponding to the workpiece.

3. The workpiece measurement method according to claim 1, wherein the evaluation function is a weighted linear sum according to the number of points in a point cloud included in the boundary frame and a point cloud density.

4. The workpiece measurement method according to claim 1, wherein the optimizing step includes optimizing the parameter including any one of a size, position, and angle of the boundary frame.

5. The workpiece measurement method according to claim 1, wherein the outline estimating step includes estimating the boundary frame by scanning the point cloud data from a plurality of directions.

6. The workpiece measurement method according to claim 1, wherein the outline estimating step includes estimating an outline by projecting the point cloud data onto a two-dimensional plane.

7. The workpiece measurement method according to claim 6, further comprising a deriving step for deriving a position corresponding to each of the plurality of components in an axial direction orthogonal to the two-dimensional plane.

8. The workpiece measurement method according to claim 1, wherein the boundary frame includes a straight line or a curved line.

9. The workpiece measurement method according to claim 1, wherein the boundary frame is indicated two-dimensionally or three-dimensionally.

10. The workpiece measurement method according to claim 1, further comprising a correcting step for correcting the at least one boundary frame optimized in the optimizing step by using a measurement result obtained by performing touch-sensing on the workpiece.

11. A workpiece measurement system that measures a shape and a position of a workpiece constituted of a plurality of components, the workpiece measurement system comprising:
acquiring means for acquiring three-dimensional point cloud data of the workpiece;
outline estimating means for estimating at least one boundary frame indicating an outline corresponding to each of the plurality of components by using the point cloud data and a condition defined in correspondence with the shape of the workpiece serving as a measurement target; and
optimizing means for optimizing the at least one boundary frame estimated by the outline estimating means by adjusting a parameter in accordance with an evaluation function, and identifying a shape of each of the plurality of components.

12. A program causing a computer to execute a process comprising:
an acquiring step for acquiring three-dimensional point cloud data of a workpiece constituted of a plurality of components;
an outline estimating step for estimating at least one boundary frame indicating an outline corresponding to each of the plurality of components by using the point cloud data and a condition defined in correspondence with a shape of the workpiece serving as a measurement target; and
an optimizing step for optimizing the at least one boundary frame estimated in the outline estimating step by adjusting a parameter in accordance with an evaluation function, and identifying a shape of each of the plurality of components.
